(19) United States
(12) Patent Application Publication
(10) Pub. No.: US 2021/0198929 A1
(43) Pub. Date: Jul. 1, 2021

(54) Mounting Bracket

(71) Applicant: Splitt Enterprises LLC, Denver, CO (US)

(72) Inventor: Eric W. Splitt, Denver, CO (US)

(21) Appl. No.: 17/058,044

(22) PCT Filed: Jun. 3, 2019
(86) PCT No.: PCT/US19/35251

§ 371 Date: Nov. 23, 2020

Related U.S. Application Data
(60) Provisional application No. 62/679,297, filed on Jun. 1, 2018.

(51) Int. Cl. E05D 15/06

(52) U.S. Cl. CPC E05D 15/0621

(57) ABSTRACT

Exemplary embodiments of methods and apparatuses for a two part mounting bracket for supporting a track or the like is provided. In some exemplary embodiments, a mounting bracket is provided, including a first portion including a front surface having a substantially flat front top surface, a substantially flat front bottom surface and a lip extending outward and perpendicular to the flat front top surface and flat front bottom surface that is provided between the flat front top surface and flat front bottom surface, and a second portion including a front surface having a substantially flat front top surface and a substantially flat front bottom surface that is configured to connect to the first portion, such that the lip provides an enclosed support between the first portion and second portion to support a track.

### CROSS-REFERENCE TO RELATED APPLICATIONS

This application relates to and claims priority from U.S. Provisional Patent Application Ser. No. 62/679,297 filed Jun. 1, 2018, the entire disclosure of which is hereby incorporated herein by reference.

### FIELD OF THE DISCLOSURE

The present disclosure relates to exemplary embodiments of a mounting bracket, and more particularly, to exemplary embodiments of a two part mounting bracket for supporting a track or the like.

### BACKGROUND INFORMATION

Various mounting brackets and the like can be used to hang tracks or other equipment in order to provide a rolling door or other apparatus. The present disclosure relates to a particular mounting bracket having two or more pieces, where two or more mounting brackets can be used for supporting a track or the like.

### SUMMARY OF EXEMPLARY EMBODIMENTS OF THE DISCLOSURE

Exemplary embodiments of the present disclosure can provide for a two part mounting bracket for supporting a track or the like, which can be used to provide support for a rolling door or other apparatus.

In some exemplary embodiments, a mounting bracket is provided, comprising a first portion including a front surface having a substantially flat front top surface, a substantially flat front bottom surface and a lip extending outward and perpendicular to the flat front top surface and flat front bottom surface that is provided between the flat front top surface and flat front bottom surface, and a second portion including a front surface having a substantially flat front top surface and a substantially flat front bottom surface that is configured to connect to the first portion, such that the lip provides an enclosed support between the first portion and second portion to support a track.

The mounting bracket can further comprise a recess provided in the substantially flat front top surface, wherein the recess includes a depth provided through a portion of the thickness of the first portion. The mounting bracket can further comprise an aperture provided within the recess having a smaller diameter than the recess that extends to a back surface of the first portion. The mounting bracket can further comprise one or more recesses provided within the substantially flat front bottom surface of the first portion. The mounting bracket can further comprise one or more recesses provided within the substantially flat front bottom surface of the second portion that align with the one or more recesses of the substantially flat front bottom surface of the first portion. In some exemplary embodiments, the one or more recesses of the first portion do not extend through the thickness of the first portion. In some exemplary embodiments, the one or more recesses of the second portion extend through the thickness of the second portion. In some exemplary embodiments, the one or more recesses of the first portion and the second portion comprise threaded portions.

In some exemplary embodiments, the mounting bracket can further comprise a lip provided between the flat front top surface and flat front bottom surface of the front surface of the second portion, the lip extending outward and perpendicular to the flat front top surface and flat front bottom surface of the second portion. In some exemplary embodiments, the lip of the second portion is aligned to contact the lip of the first portion when the first portion and second portion are mated to provide the support for the track. In some exemplary embodiments, a height of the front surface of the first portion and a height of the second portion are approximately the same, and a height of the lip of the first portion and a height of the lip of the second portion are approximately the same. In some exemplary embodiments, a height of the front surface of the first portion and a height of the second portion are approximately the same.

In some exemplary embodiments, the mounting bracket can further comprise an extension block configured to mount to a back surface of the first portion, the extension block configured to provide a distance from a wall that the first portion is mounted to, the distance being equal to a thickness of the extension block. In some exemplary embodiments, the second portion has a substantially flat back surface. In some exemplary embodiments, the mounting bracket can further comprise a first notch provided on a first side surface of the first portion, and a second notch provided on a second side surface of the first portion opposite of the first side surface. In some exemplary embodiments, the first notch and second notch extend from a top surface of the first portion and terminate prior to the bottom surface of the first portion.

### BRIEF DESCRIPTION OF THE DRAWINGS

The foregoing and other objects of the present disclosure will be apparent upon consideration of the following detailed description, taken in conjunction with the accompanying drawings, and claims, in which like reference characters refer to like parts throughout, and in which:

FIG. 1 is an illustration of a first portion of a mounting bracket according to an exemplary embodiment of the present disclosure;

FIG. 2 is an illustration of a second portion of a mounting bracket according to an exemplary embodiment of the present disclosure;

FIGS. 3(a)-3(k) are illustrations of the mounting bracket being used to support a track according to an exemplary embodiment of the present disclosure;

FIG. 4 is an illustration of a first portion of a mounting bracket according to an exemplary embodiment of the present disclosure;

FIG. 5 is an illustration of a second portion of a mounting bracket according to an exemplary embodiment of the present disclosure;

FIG. 6 is an illustration of a first portion of a mounting bracket and an extension block according to an exemplary embodiment of the present disclosure;

FIG. 7 is an illustration of a mounting bracket according to an exemplary embodiment of the present disclosure; and

FIG. 8 is an illustration of a plurality of mounting brackets being used to support a track according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

The exemplary embodiments of the present disclosure can provide for a two part mounting bracket for supporting a track or the like. The track can be provided between the two parts of the mounting bracket, and the track can support roller hardware that rolls along the track without interfering with or touching the mounting bracket. The roller hardware can in turn be connected or attached to a door or other similar apparatus, allowing the door or other apparatus to slide along the track without interfering with the mounting bracket.

Exemplary embodiments of the various methods and apparatuses will now be described with reference to the figures. The following description of the various embodiments is merely exemplary in nature and is in no way intended to limit the scope of the disclosure, its application, or uses.

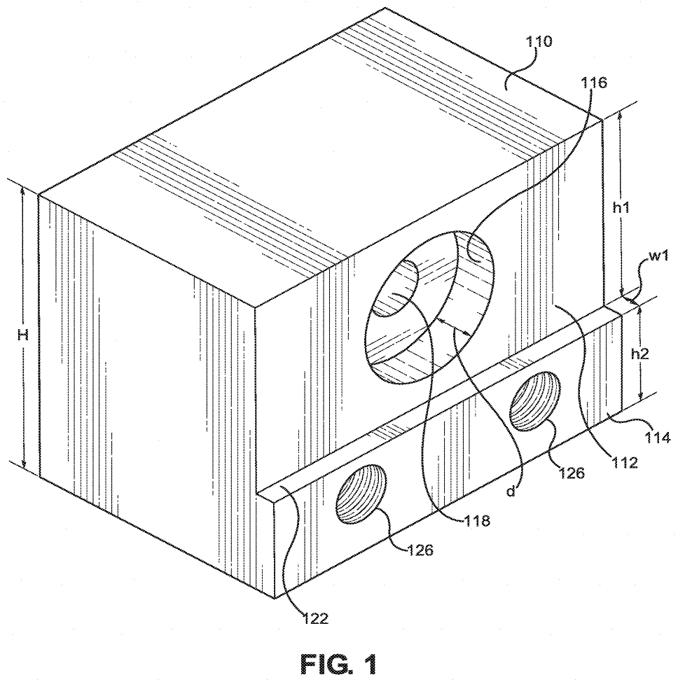

FIG. 1 is an illustration of a first portion 110 of a mounting bracket 100 according to an exemplary embodiment of the present disclosure. The first portion 110 can be made of various materials, such as wood, metal (e.g., steel, aluminum), paper, plastic or a combination of the materials. The first portion 110 can have a top front surface 112 and a bottom front surface 114, which can both have a flat contour, and have a height H. The top front surface 112 can be substantially flat and have a recess 116, and can have a height h1. The recess 116 can be but is not limited to a circular shape, and can have a depth d recessed into the first portion 110. The recess 116 can have an aperture 118 in the center of the recess 116 that extends through the thickness of the first portion 110 to the opposing side of the top front surface 112. In use, a bolt can be placed within the recess 116 such that a head of the bolt is placed within recess 116 and the head has a thickness less than the depth d, and a shank of the bolt extends through the aperture 118 such that the bolt can be secured to a wall or stud in the wall, as will be further described below. In some exemplary embodiments, threads can be provided within the aperture 118 to secure the bolt.

The bottom front surface 114 can be substantially flat, and can have a recess 126. In some exemplary embodiments, the bottom front surface 114 can have two recesses 126 as shown in FIG. 1. The recesses 126 can extend into the first portion 110. In some exemplary embodiments, the recesses 126 do not extend through the entire first portion 110, but approximately halfway into the first portion 110. In some exemplary embodiments, threads can be provided within the recesses 126 as will be further described below. A lip 122 can be provided between the top front surface 112 and the bottom front surface 114, such that the lip 122 is perpendicular to both the top front surface 112 and the bottom front surface 114. The lip 122 can be provided at a height h2 as shown in FIG. 1, which is similar to a height of the bottom front surface 114. The lip 122 can have a width w1. The height H of the first portion 110 is cumulative of the height h1 of the top front surface 112 and the bottom front surface 114.

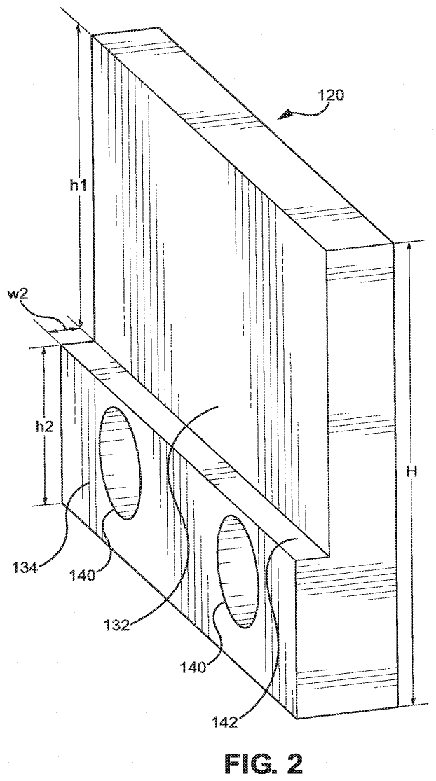

FIG. 2 is an illustration of a second portion 120 of a mounting bracket 100 according to an exemplary embodiment of the present disclosure. Similar to the first portion 110, the second portion 120 can be made of various materials, such as wood, metal (e.g., steel, aluminum), paper, plastic or a combination of the materials. In some exemplary embodiments, the first portion 110, and second portion 120 are made of the same material(s). The second portion 120 can have a top front surface 132 and a bottom front surface 134, which can both have a flat contour, and have a height H. In some exemplary embodiments, the height H of the second portion 120 can be similar to the height H of the first portion 110. The top front surface 132 can be substantially flat and can have a height h1, which can be similar to the height h1 of the top front surface 112 of the first portion 110. In some exemplary embodiments, the thickness of the second portion 120 can be less than the thickness of the first portion 110.

The bottom front surface 134 can be substantially flat, and can have a recess 140. In some exemplary embodiments, the bottom front surface 134 can have two recesses 140 as shown in FIG. 2. In some exemplary embodiments, the recesses 140 can extend through the entire thickness of the second portion 120. In some exemplary embodiments, threads can be provided within the recesses 140 as will be further described below. The recesses 140 can match up with the recesses 126 of the first portion 110, as will be further described below. A lip 142 can be provided between the top front surface 132 and the bottom front surface 134, such that the lip 142 is perpendicular to both the top front surface 132 and the bottom front surface 134. The lip 142 can be provided at a height h2 as shown in FIG. 2, which is similar to a height of the bottom front surface 134. The height h2 of the bottom front surface 134 can be similar to the height h2 of the bottom front surface 114 of the first portion 110. The lip 142 can have a width w2, which can be equal or similar to the width w1 of the lip 122 of the first portion 110. The height H of the second portion 120 is cumulative of the height h1 of the top front surface 132 and the bottom front surface 134.

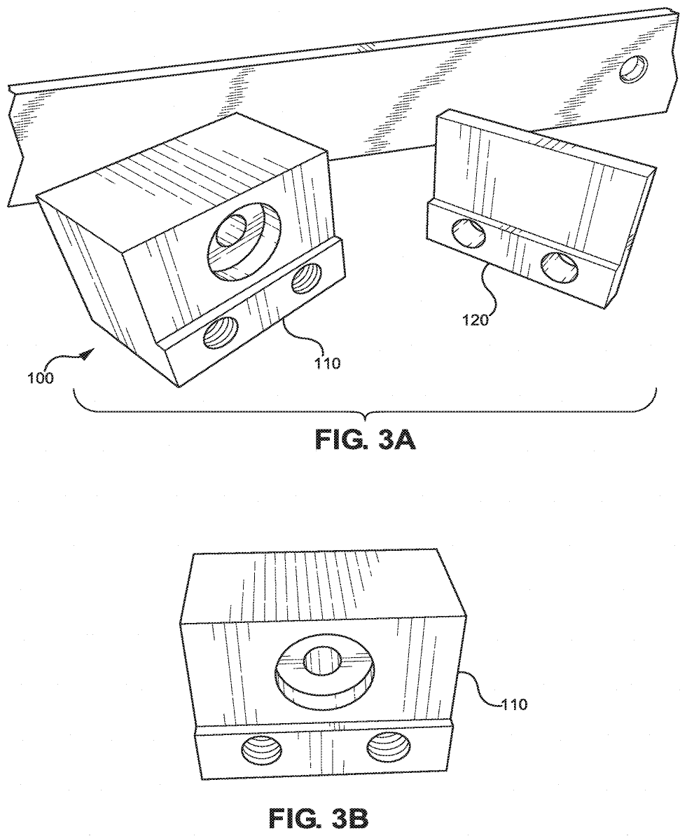

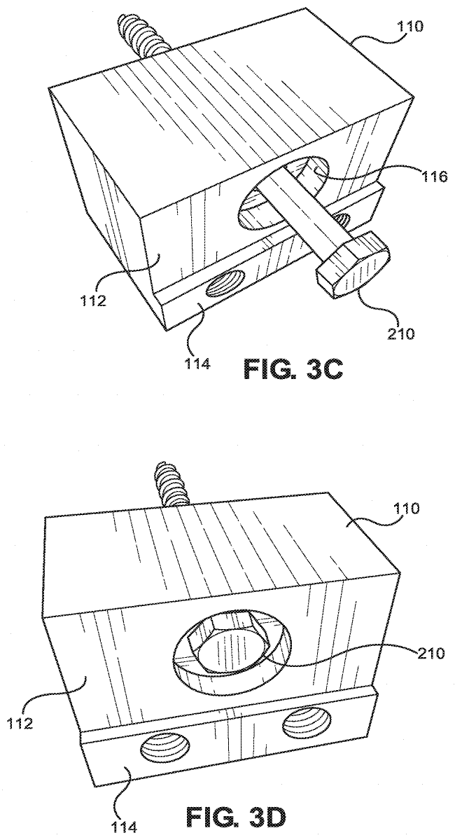

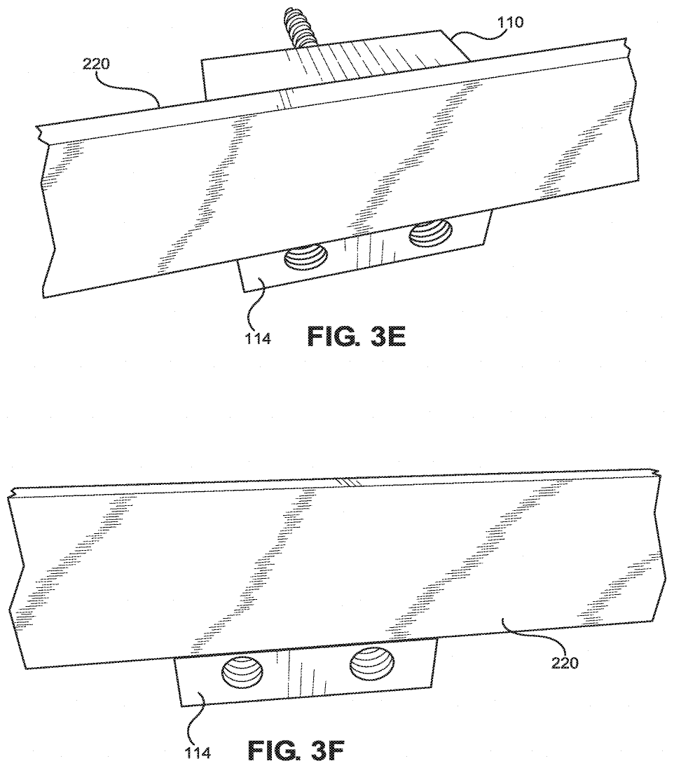

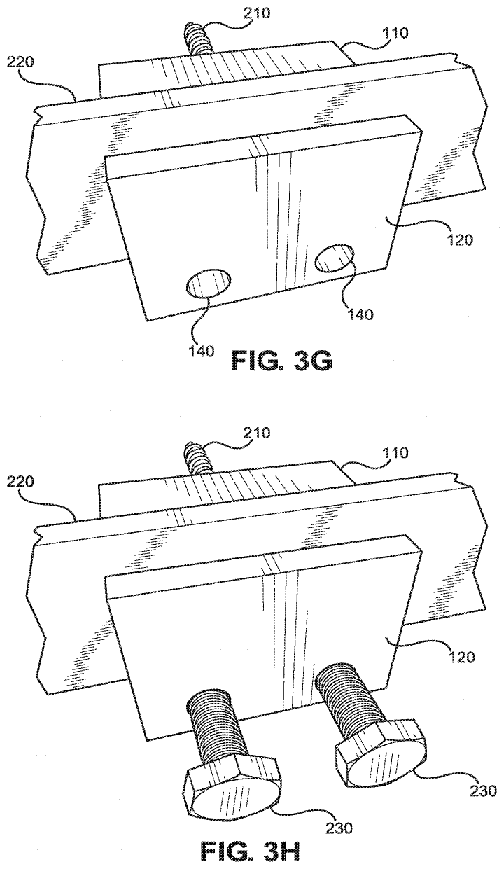

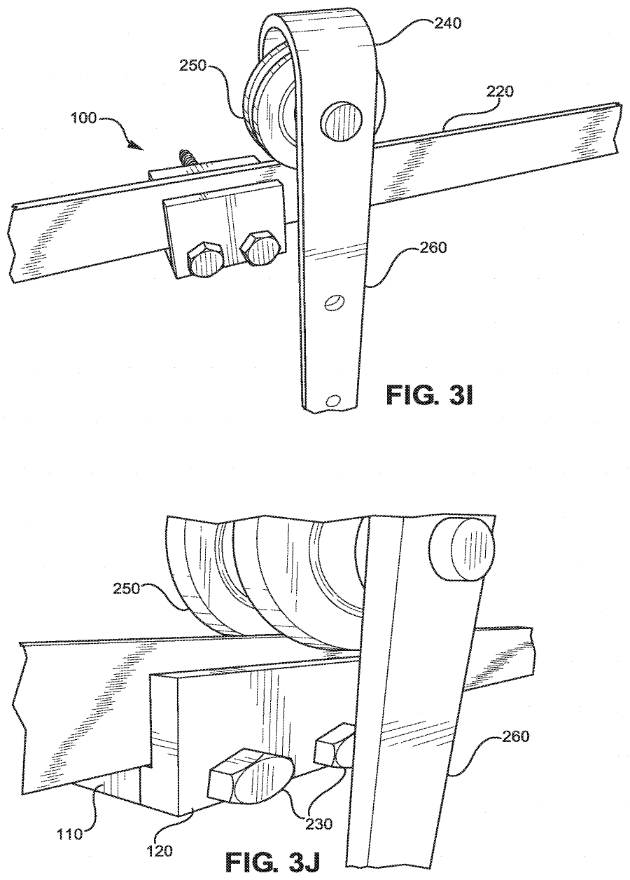

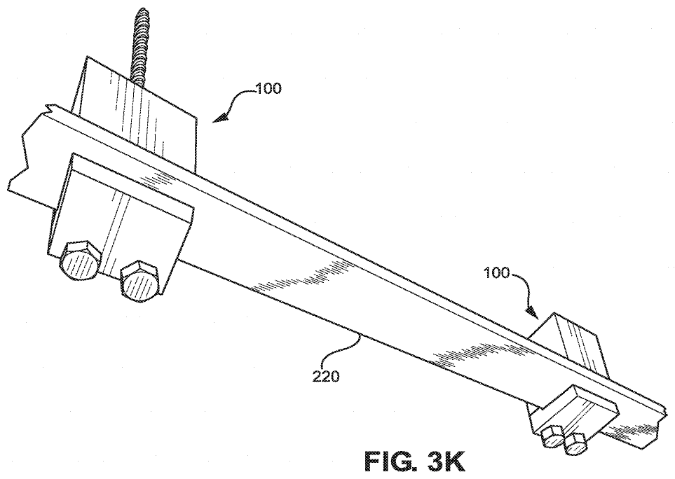

FIGS. 3(a)-3(k) are illustrations of the mounting bracket 100 being used to support a track according to an exemplary embodiment of the present disclosure. As shown in FIG. 3(a), the first portion 110 and second portion 120 can be used together to form a mounting bracket 100. As shown in FIGS. 3(b) and 3(c), a bolt 210 (or wall anchor for mounting into brick or concrete) is placed into the recess 116, such that the shank of the bolt 210 is inserted into the aperture 118. In some exemplary embodiments, a hole can be pre-drilled into a wall into a stud. As shown in FIG. 3(d), the bolt 210 is tightened into the hole in the wall (and stud, if needed) such that the head of the bolt 210 is completely within the recess 116.

As shown in FIGS. 3(e) and 3(f), a track 220 can be placed on the lip 122 of the first portion 110. As shown in FIG. 3(g), the second portion 120 is placed side by side with the first portion 110, such that the bottom front surface 114 of the first portion 110 abuts the bottom front surface 134 of the second portion 120. The lip 122 of the first portion 110 is at the same height as the lip 142 of the second portion 120, which allows the track 220 to sit on the lips 122 and 142. One skilled in the art would understand that the heights of the bottom front surface 114 and the bottom front surface 134 do not have to be identical, as long as the lips 122 and 142 match up in use. The width of the track 220 can be equal to or slightly less than the combined width of the lips 122 and 142 (w1+w2), allowing a snug fit of the track 220 within the first portion 110 and second portion 120. In some exemplary embodiments, a piece or rubber or anti-slip material can be used between the track 220 and the lips 122, 142 of the first portion 110 and second portion 120, respectively, to provide additional grip of the track 220 with the first portion 110 and second portion 120. The recesses 140 of the second portion 120 are aligned with the recesses 126 of the first portion 110.

As shown in FIG. 3(h), bolts 230 can be inserted into the recesses 140 of the second portion 120 and then tightened into the recesses 126 of the first portion 110, such that the track 220 is secured within the first portion 110 and the second portion 120 of the mounting bracket 100. As shown in FIGS. 3(i) and 3(j), roller hardware 240 can slide along the top of the track 220. The roller hardware can include a roller 250, and a bar 260 that is connected to the roller 250 at a top end and an apparatus (such as a barn door) on a bottom end. As shown in FIG. 3(j), a sufficient clearance is provided between the roller 250 and the mounting bracket 100 such that the roller 250 does not touch or engage with the mounting bracket 100, and the roller 250 can roll over the mounting bracket 100. A sufficient clearance is also provided between the bar 260 and the mounting bracket 100 (and bolts 230) such that they do not engage with or touch the bar 260. In some exemplary embodiments, as shown in FIG. 3(k), two or more mounting brackets 100 can be used to support the track 220 as needed for support to roll an apparatus along an entire length of the track 220. Two or more mounting brackets 100 can be used as needed, depending on the distance of the track 220.

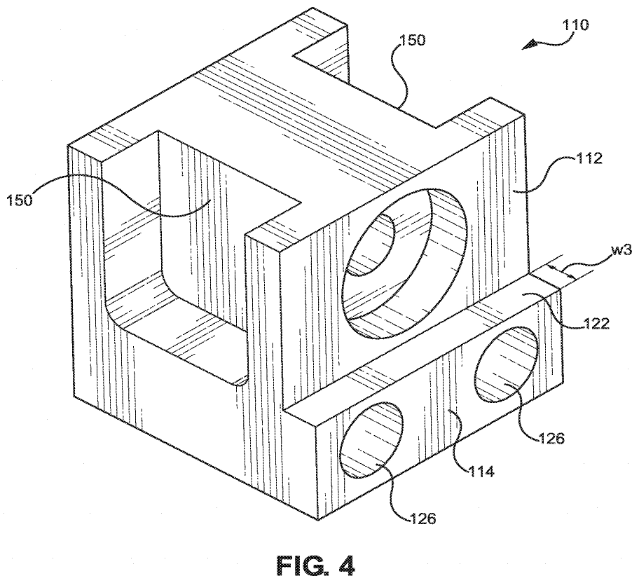

FIG. 4 is an illustration of a first portion of a mounting bracket according to an exemplary embodiment of the present disclosure. As shown in FIG. 4, the first portion 110 can have notches 150 on the side surfaces of the first portion. These can reduce the weight and cost of the first portion 110, as well as provide areas to grip the first portion during installation of the first portion 110. The notches 150 can extend from a top surface of the first portion 110 and terminate prior to the bottom surface of the first portion. In some exemplary embodiments, the notches can have a height that correspond to the height of the top front surface 112 of the first portion 110. In this exemplary embodiment, the lip 122 of the first portion 110 can be made wide enough to support a track such that the second portion 120 does not need to have a lip, as discussed below. That is, the width w3, can be equal to the width w1 of the first portion 110 in FIG. 1 plus the width w2 of the second portion 120 in FIG. 2.

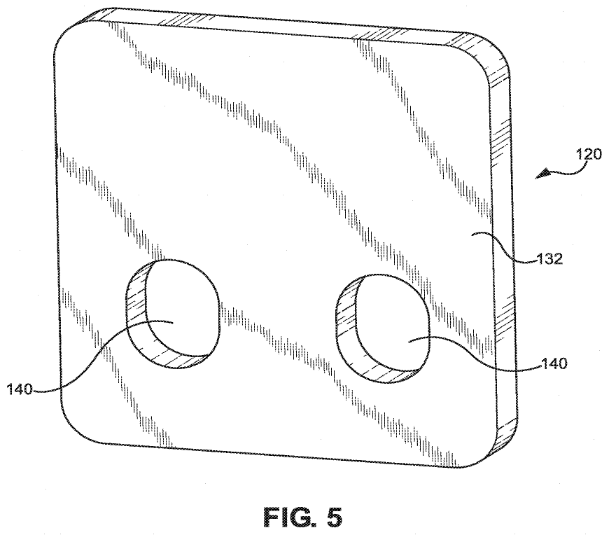

FIG. 5 is an illustration of a second portion of a mounting bracket according to an exemplary embodiment of the present disclosure. The second portion 120 can have a front surface 132 that is completely flat from a top to a bottom as shown. Recesses 140 are provided to correspond to the recesses 126 of the first portion 110 as shown in FIG. 4. Because the lip 122 of the first portion 110 in FIG. 4 is wide enough to support a track, the second portion 120 in FIG. 5 does not need to have a lip and the front surface 132 of the second portion 120 can be flat. In some exemplary embodiments, the second portion 120 (along with the first portion 110 and extension block 180, as described below) can have rounded corners to prevent parts being caught during installation or use.

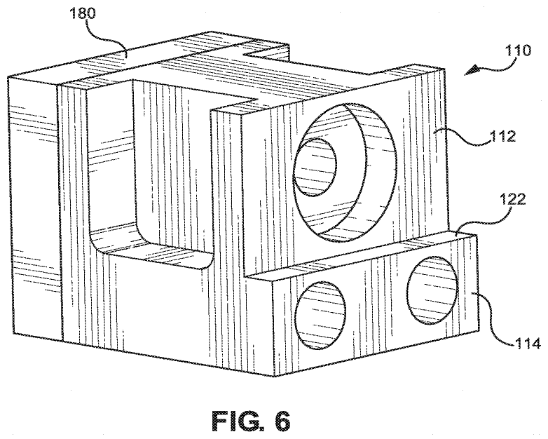

FIG. 6 is an illustration of a first portion of a mounting bracket and an extension block according to an exemplary embodiment of the present disclosure. As shown in FIG. 6, an extension block 180 that can be substantially flat along a front and back surface can be placed flush against a back portion of the first portion 110. The extension block 180 acts as a spacer to keep the mounting bracket 100 further from the wall for, e.g., allowing thicker doors to be used along a track. The distance from the wall can correlate to a thickness of the extension block 180. One or more extension blocks 180 can be used in conjunction if a thicker door is being used, or extension blocks of varying thicknesses can be designed to accommodate various door thicknesses. In some exemplary embodiments, the extension block 180 is first attached to first portion 110 before the first portion is mounted to a wall or stud. One or more recesses can be provided on a back portion of extension block 180 to connect e.g., screws or other securing mechanisms to first portion 110. In some exemplary embodiments, the extension block 180 can have recesses that align with recesses in the first portion to allow for easy securing of the extension block 180 to the first portion 110. In some exemplary embodiments, where more than one extension block 180 is used, each extension block 180 can have recesses corresponding to the other extension blocks.

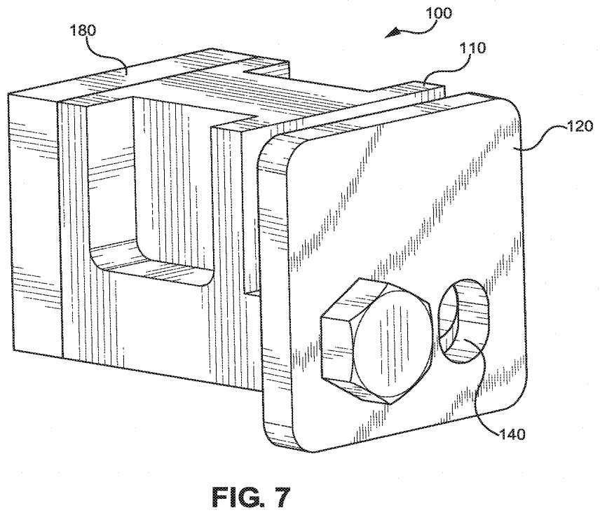

FIG. 7 is an illustration of a mounting bracket 100 according to an exemplary embodiment of the present disclosure. As shown in FIG. 7, after the extension block 180 is mounted to the first portion 110, and first portion 110 is secured to a wall or stud in the wall, second portion 120 can be secured to the first portion using e.g., bolts or screws inserted into the recesses 140 of the second portion 120 and the recesses 126 of the first portion 110. In some exemplary embodiments, as shown in FIG. 7, a height of the second portion 120 can be greater than a height of the first portion 110.

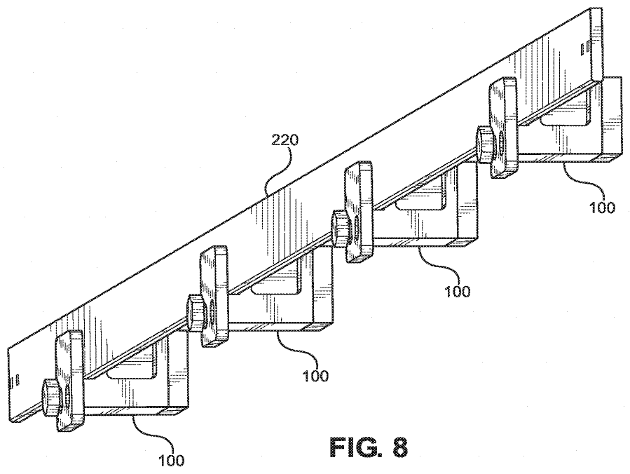

FIG. 8 is an illustration of a plurality of mounting brackets 100 being used to support a track 220 according to an exemplary embodiment of the present disclosure. As shown in FIG. 8, a plurality of mounting brackets 100 can be secured to a wall (not shown) to provide support for a track 220 within the lips of the first portion 110 and second portion 120, or just the lip of the first portion 110. Those skilled in the art would understand that various design choices can be made, such as a lip provided in the second portion 120 and not the first portion 110. For ease of installation, it can be preferable that the lip is provided on the first portion 110.

Various other considerations can also be addressed in the exemplary applications described according to the exemplary embodiments of the present disclosure. For example, various materials may be used to construct the elements described in the figures, such as the first portion 110, the second portion 120 and the extension block 180. Various sizes and dimensions of the first portion 110, the second portion 120 and the extension block 180, and of the shapes and designs for the first portion 110, the second portion 120 and the extension block 180 can also be provided, and are not limited by the sizes, dimensions, shapes and designs described above and in the figures.

Various advantages can be provided based on the exemplary embodiments described above. For example, provided a mounting bracket 100 as described above can provide a track for rolling various apparatuses, such as but not limited to doors, sliding doors (such as a sliding barn door), windows, curtains or drapery. Additionally, the exemplary embodiments of the present disclosure can allow for flexible placement directly on each stud, provide less damage to a drywall from over tightening, be less likely to sag under heavy loads, provide easy to connect multiple tracks together for wide doors, and allow for thicker doors to be used or connected with the rolling hardware.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure.

What is claimed is:

1. A mounting bracket, comprising:
a first portion including a front surface having a substantially flat front top surface, a substantially flat front bottom surface and a lip extending outward and perpendicular to the flat front top surface and flat front bottom surface that is provided between the flat front top surface and flat front bottom surface; and
a second portion including a front surface having a substantially flat front top surface and a substantially flat front bottom surface that is configured to connect to the first portion, such that the lip provides an enclosed support between the first portion and second portion to support a track.

2. The mounting bracket of claim 1, further comprising:
a recess provided in the substantially flat front top surface, wherein the recess includes a depth provided through a portion of the thickness of the first portion.

3. The mounting bracket of claim 2, further comprising:
an aperture provided within the recess having a smaller diameter than the recess that extends to a back surface of the first portion.

4. The mounting bracket of claim 1, further comprising:
one or more recesses provided within the substantially flat front bottom surface of the first portion.

5. The mounting bracket of claim 4, further comprising:
one or more recesses provided within the substantially flat front bottom surface of the second portion that align with the one or more recesses of the substantially flat front bottom surface of the first portion.

6. The mounting bracket of claim 5, wherein the one or more recesses of the first portion do not extend through the thickness of the first portion.

7. The mounting bracket of claim 5, wherein the one or more recesses of the second portion extend through the thickness of the second portion.

8. The mounting bracket of claim 1, wherein the one or more recesses of the first portion and the second portion comprise threaded portions.

9. The mounting bracket of claim 1, further comprising:
a lip provided between the flat front top surface and flat front bottom surface of the front surface of the second portion, the lip extending outward and perpendicular to the flat front top surface and flat front bottom surface of the second portion.

10. The mounting bracket of claim 9, wherein the lip of the second portion is aligned to contact the lip of the first portion when the first portion and second portion are mated to provide the support for the track.

11. The mounting bracket of claim 10, wherein a height of the front surface of the first portion and a height of the second portion are approximately the same, and a height of the lip of the first portion and a height of the lip of the second portion are approximately the same.

12. The mounting bracket of claim 1, wherein a height of the front surface of the first portion and a height of the second portion are approximately the same.

13. The mounting bracket of claim 1, further comprising:
an extension block configured to mount to a back surface of the first portion, the extension block configured to provide a distance from a wall that the first portion is mounted to, the distance being equal to a thickness of the extension block.

14. The mounting bracket of claim 1, wherein the second portion has a substantially flat back surface.

15. The mounting bracket of claim 1, further comprising:
a first notch provided on a first side surface of the first portion; and
a second notch provided on a second side surface of the first portion opposite of the first side surface.

16. The mounting bracket of claim 15, wherein the first notch and second notch extend from a top surface of the first portion and terminate prior to the bottom surface of the first portion.
